(19) United States
(12) Patent Application Publication
(10) Pub. No.: US 2025/0356432 A1
(43) Pub. Date: Nov. 20, 2025

(54) DEVICES, USER INTERFACES, SYSTEMS FOR AND METHODS OF MANAGING ACCOUNT TRANSACTIONS

(71) Applicant: Blue Diamond Investing LLC, Carol Stream, IL (US)

(72) Inventors: John J. King, JR., Wheaton, IL (US); Jacob A. Ramsey, Carol Stream, IL (US); Alexander D. Szewczyk, Bartlett, IL (US)

(73) Assignee: Blue Diamond Investing LLC, Carol Stream, IL (US)

(21) Appl. No.: 19/282,973

(22) Filed: Jul. 28, 2025

(51) Int. Cl. G06Q 40/12; G06Q 40/06

(52) U.S. Cl. CPC G06Q 40/124; G06Q 40/065

(57) ABSTRACT

According to one aspect, a communication device for processing financial transaction data may comprise a communication interface for receiving financial data; a processor coupled to the communication interface and adapted to receive the financial data; and a display coupled to the processor and adapted to display financial data; wherein the processor is adapted to allocate financial data to one or both of a primary balance sheet and an auxiliary balance sheet.

### TECHNICAL FIELD

An embodiment of the present invention relates generally to accounting of financial transactions, and more particularly to devices, user interfaces, systems and methods of managing account transactions.

### BACKGROUND

Managing finances is an important part of daily life for many, and financial stress can have an adverse effect on an individual's physical and mental health. While people resort to many different ways of managing finances, including the use of software tools, it is often difficult to track some expenses of an individual or family that may be sporadic, intermittent, or unexpected. These expenses may often make budgeting difficult. These expenses may lead to a monthly budget report that may be difficult to understand, and possibly alarming. That is, because of sporadic, intermittent, or unexpected expenses, it may be that a person is significantly over budget for a given period, such as a month. Such a budget report may not only cause concern for the person, but may cause the person to stop trying to work with a budget because of the inability to understand sporadic, intermittent, or unexpected expenses

Savings is also an important aspect in the lives of many people, but savings can be challenging for many and may be difficult for people to implement. While the concept of savings may be attractive to many, there may not be incentives or a motivation for some to save. Similarly, investing can be an important tool for people to provide for their future, investing may often be difficult. People are often faced with decisions of how much to save and have available as a liquid asset and how much to have tied up in long term savings or investments. Investment tools may not be tied to a bank of a user. Rather, they may not only be handled by separate tools, but may not be considered as a part of an overall financial management strategy.

Accordingly, it is beneficial to have devices, user interfaces, systems and methods of managing account transactions that take into account all aspects of the financial management of a user.

### SUMMARY

According to one aspect, a communication device for processing financial transaction data may comprise a communication interface for receiving financial data; a processor coupled to the communication interface and adapted to receive the financial data; and a display coupled to the processor and adapted to display financial data; wherein the processor is adapted to allocate financial data to one or both of a primary balance sheet and an auxiliary balance sheet.

According to another aspect, a computer-readable storage medium having data stored therein representing software executable by a computer for processing financial transaction data may comprise instructions for receiving financial data; instructions for a processor coupled to the communication interface and adapted to receive the financial data; and instructions for a display coupled to the processor and adapted to display financial data; wherein the processor is adapted to allocate financial data to one or both of a primary balance sheet and an auxiliary balance sheet.

A method of processing financial transaction data may comprise receiving financial data by way of a communication interface; coupling a processor to the communication interface, wherein the processor is adapted to receive the financial data; and coupling a display to the processor, wherein the display adapted to display financial data; allocating, by the processor, financial data to one or both of a primary balance sheet and an auxiliary balance sheet.

### BRIEF DESCRIPTION OF THE DRAWINGS

FIG. 1 is a block diagram of a system for managing electronic business transactions.

FIG. 2 is a block diagram of communication device.

FIG. 3 is a block diagram of a data processing center.

FIG. 4 is a tree diagram associated with a user interface of a communication device.

FIG. 5 is a layout of a budget user interface.

FIG. 6 is a flow chart showing a method of implementing a budget user interface.

FIG. 7 is a layout of a budget category user interface.

FIG. 8 is a flow chart showing a method of implementing a budget category user interface.

FIG. 9 is a layout of selected entry from a budget category user interface.

FIG. 10 is a flow chart showing a method of editing a selected entry of a budget category.

FIG. 11 is a layout of a user interface to update an expense entry.

FIG. 12 is a layout of a user interface to create a new category for a budget.

FIG. 13 is a flow chart showing a method of creating a new category for a budget.

FIG. 14 is a layout of a user interface for selecting information associated with a new category.

FIG. 15 is a layout of a user interface for uploading a financial statement to a budget.

FIG. 16 is another layout of a user interface for uploading a financial statement to a budget.

FIG. 17 is a layout of a user interface for entering an expense to a budget.

FIG. 18 is a layout of a user interface for accessing fund categories and entries and saving goals categories and entries.

FIG. 19 is a flow chart showing a method of implementing a budget having auxiliary funds.

FIG. 20 is a flow chart showing a method of implementing a budget having savings goals.

FIG. 21 is a layout of a user interface of an investment category of a budget.

FIG. 22 is a layout of a user interface enabling the entry of a new category.

FIG. 23 is another layout of a user interface of an investment category of a budget showing an entry associated with a managed investment account.

FIG. 24 is a flow chart showing a method of implementing a user interface of an investment category of a budget.

FIG. 25 is a layout of a user interface showing additional icons to access additional information and control an operation of the user interface.

FIG. 26 is a layout of a user interface enabling a user to access frequently asked questions.

### DETAILED DESCRIPTION

The devices, user interfaces, systems and methods of managing account transactions enable a user to improve their understanding and management of their income and expenses, improve the management of their available financial resources, and provide opportunities and improved strategies for the user to save and invest. Because it is tedious and time consuming to enter a transactions history associated with a financial institution, the devices, user interfaces, systems and methods of managing account transactions allow for the importing of financial statements, such as CSV file statements, without needing to connect directly to financial institutions nor enter each transaction manually. In some circumstances, software programs or apps that provide financial management for accounts require a user to pay a service fee to enable the software company or app to access financial statements from the financial institution of a user. As will be described in more detail below, the devices, user interfaces, systems and methods of managing account transactions enable a user to easily access the financial statements at no cost to a user.

According to some implementations, methods of uploading statements from financial platforms are described. The devices, user interfaces, systems and methods make it possible to parse through a full statement of transactions. The devices, user interfaces, systems and methods allow a user to quickly import all of their spending history rather than manually entering each transaction from one or more accounts that is accessed by a user. The devices, user interfaces, systems and methods may allow the user to simultaneously view a web browser pop-up and side-by-side with directions tailored to the specific financial platform from which the user wishes to download a statement. According to some implementations, transactions may be automatically categorized into budget categories based on categorizations from previous transactions, categorizations of classifications specified by the financial institution, the use of artificial intelligence relying upon available information of a user or group of users, or by any other means at the time when the statement is uploaded.

According to other implementations, the devices, user interfaces, systems and methods relate to the creation and modification of auxiliary balance sheets. Contributions to the auxiliary funds may be logged as an expense in a primary balance sheet, which may represent a main monthly balance sheet. A primary balance sheet may comprise a category associated with one or more savings accounts, and may include a desired savings amount. An auxiliary balance sheet displays financial transactions for recorded expenses for a selected period of time, as will be described in more detail below. An auxiliary balance sheet may display a cumulative amount of saving for a selected time period. The auxiliary balance sheet may display financial transactions for recorded expenses for a selected period of time. The user can make withdrawals from the auxiliary balance sheet for sporadic, intermittent, or unexpected expenses, which may be considered generally as irregular expenses. These intermittent expenses may be difficult to predict or estimate on a monthly basis, but possibly easier to predict or estimate on an annual basis. The use of an auxiliary balance sheet allows the user to keep these irregular expenses off of the primary balance sheet, so as to enable a user to closely track their monthly spending in a way that will allow them to more easily identify when they are exceeding their budget in areas that are easy to track, and also to allocate room in the budget for irregular expenses that will likely be allocated at different times of the year. By using an auxiliary balance sheet as described below, the devices, user interfaces, systems and methods also allow the user to smooth the expenses over the course of a year by breaking it down into more manageable monthly expenses (i.e., auxiliary balance sheet contributions), knowing that those expenses will not necessarily be incurred, but that on average over the year, expenses in those categories will be incurred over the year and will be equal to (or hopefully less than) the budgeted amount for the year.

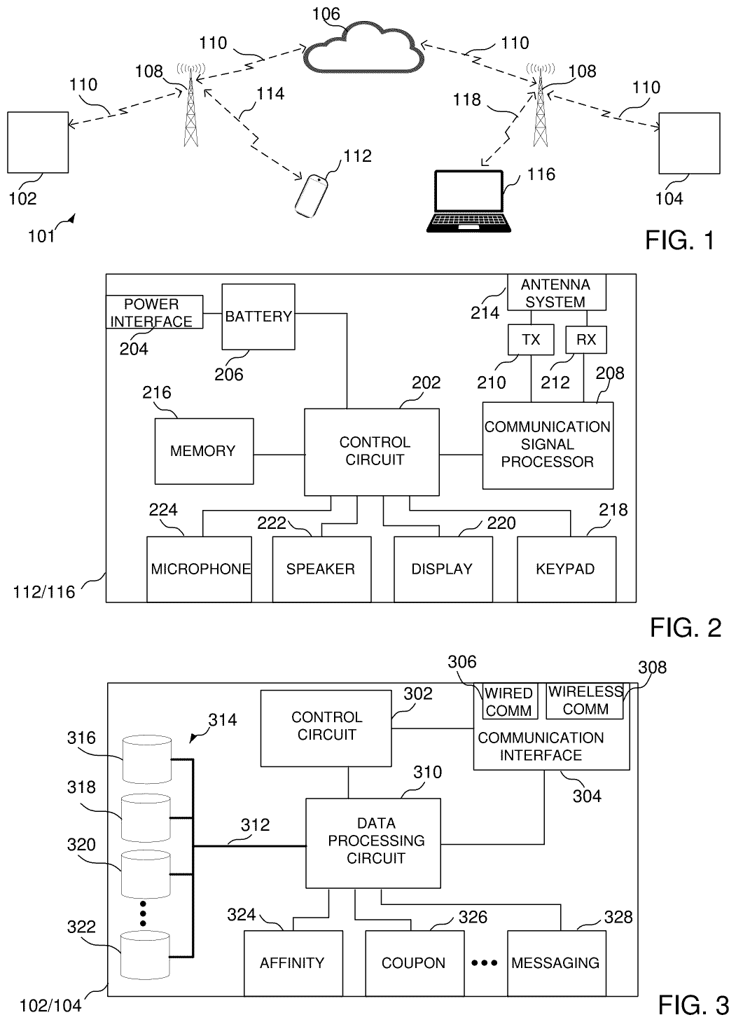

Turning first to FIG. 1, a block diagram of a system 101 for managing electronic business transactions is shown. Data processing devices 102 and 104, which may be computers or servers associated with computing centers associated with financial institutions, may be coupled to a cloud network 106 by way of a communication network, designated by wireless communication nodes 108. Data processing devices may be operated by financial institutions that manage electronic business transactions. Examples of financial institutions could include banks, credit unions, investment companies, or companies that provide one or more of banking, credit, investment or financial services, for example. The wireless communication network may be for example a cellular communication network or a WiFi network that enables communication links 110 between elements of the system 101.

While the communication network is shown as a wireless communication network, it may rely upon wired communication resources, such as landline networks, and may comprise a combination of one or more different wired or wireless communication networks or communication links, including cellular, landline, WiFi, Zigbee, Z-Wave, NFC, Bluetooth, Matter enabled communication links, and proprietary communication links for example. The data processing devices 102 and 104 are remote from a communication device 112 that is adapted to communicate with the data processing devices 102 and 104 by way of a communication link 114 and a communication device 116 adapted to communicate with the data processing devices 102 and 104 by way of a communication link 118. Electronic business transactions could include any type of business transaction that involves the transfer of funds or information from one entity to another, which may be automatically generated or generated in response to an action of an operator of a data processing device 102 or data processing device 104 or a user of a communication device 112 or 116.

The communication device 112 may be a mobile communication device, a portable computer or tablet adapted to communicate over a cellular network for example. The communication device 116 may be a laptop computer or tablet computer for example. Although the communication device 116 is shown by way of example as a laptop computer, it should be understood that communication device 116 could be any type of fixed or wired computing device, such as a desktop computer for example. It should be further understood that data processing could be distributed and performed in one or more devices of the system 101, such as at the data processing devices 102 and 104, remote processing computers of the cloud network 106 or in the communication device 112 or the communication device 116, and that data storage could be distributed and stored in one or more devices of system 101, such as at the data processing devices 102 and 104, remote memory elements of the cloud network 106 or in memory of the communication device 112 or the communication device 116, as will be described in more detail below. However, it should be understood that all of the data could be stored on the wireless communication device according to some implementations.

Turning now to FIG. 2, a block diagram of a communication device, such as communication device 112 or 116, is shown. The communication device may comprise a control circuit 202 that interfaces with, receives information from, provides information to, and controls the operation of other elements of the communication device. By way of example, the communication device 202 may be a processor, such as a central processing unit (CPU), a graphics processing unit (GPU), a digital signal processor (DSP), an application-specific integrated circuit (ASIC), a system on a chip, a field programmable device, such as a programmable logic device (PLD) or field programmable gate array (FPGA), or a combination of two or more of these devices. The control circuit may provide power to other devices of the communication device by a power interface 204 directly or by way of a rechargeable battery 206 for example.

A communication signal processor 208 is coupled to the control circuit 202 and enables wired or wireless communication with other devices. According to some implementations, the communication signal processor may provide communication signals to a transmitter 210 and receive communication signals from a receiver 212. For a wireless communication interface, the transmitter and receiver would be coupled to an antenna system 214. Although a wireless interface is shown, it should be understood that multiple communication interfaces could be used, including communication interfaces adapted to implement any wired or wireless communication protocol.

The communication device may comprise a variety of interfaces coupled to the control circuit. For example, the communication device may comprise a keypad 218, a display 220, which may be a touchscreen display as commonly used on mobile devices such as cellular phones, tablets or laptop computers, a speaker 222 and a microphone 224. However, it should be understood that the communication device may comprise any other type of input/output interface for receiving or transmitting information.

The communication device may also comprise one or more memory elements 216. The memory may store code for implementing the various operations of the communication device, and particularly, computer-readable medium comprising code for implementing methods of managing account transactions as will be described in more detail below. The memory may also store data that is processed according to a method of managing account transactions and displayed to a user on a display of the communication device. The memory elements may be fixed or removable. Examples of memory element include random access memory (RAM) and read-only memory (ROM) as is commonly used in mobile devices, and may be implemented using solid state devices (SSDs), flash memory such as UFS memory, embedded multimedia cards (eMMCs), or any other type of memory device. While various elements of the communication device are shown, it should be understood that other elements could be implemented, or that the various elements could be implemented using a plurality of devices.

Turning now to FIG. 3, a block diagram of a data processing device 102 or data processing device 104 is shown. The data processing device comprises a control circuit 302, which may be one or more of a processor, such as a central processing unit (CPU), a graphics processing unit (GPU), a digital signal processor (DSP), an application-specific integrated circuit (ASIC), a system on a chip, a field programmable device, such as a programmable logic device (PLD) or field programmable gate array (FPGA), or a combination of two or more of these devices. The control circuit may be coupled to one or more communication interfaces 304, shown here by way of example as having one or more wired communication interfaces 306 and one or more wireless communication interfaces 308. The wired and wireless communication interfaces may be implemented to communicate, directly or indirectly, with any device of the system 101 for implementing the system and methods of managing account transactions, as described in more detail below.

A data processing circuit 310 coupled to the control circuit 302 may be implemented using one or more of a graphics processing unit (GPU), a digital signal processor (DSP), an application-specific integrated circuit (ASIC), a system on a chip, a field programmable device, such as a programmable logic device (PLD) or field programmable gate array (FPGA), or a combination of two or more of these devices. It should be understood that the control circuit 302 and the data processing circuit 310 could be implemented in one device, or implemented together using a number of different devices. A memory block 314, which may comprise a plurality of memory elements, shown here by way of example as memory element 316, memory element 318, memory element 320, and memory element 322, may be coupled to the data processing circuit by a memory bus 312 and controlled by the control circuit 302. The memory elements may store code for implementing the various operations of the data processing devices, and particularly, computer-readable code for implementing methods of managing account transactions as will be described in more detail below. The memory may also store data that is processed according to a method of managing account transactions and displayed to a user on a display of the communication device. The memory elements may be fixed or removable. Examples of memory element include random access memory (RAM) and read-only memory (ROM) as is commonly used in mobile devices, and may be implemented using solid state devices (SSDs), flash memory such as UFS memory, embedded multimedia cards (eMMCs), or any other type of memory device. The data processing circuit 310 and memory block 314 are adapted to implement the system 101 and methods of managing account transactions, as described in more detail below. It should be understood that the memory block 314 may be implemented partially or completely separate from a data processing device 102 or 104. That is, the data processing device 102 or 104 may access data or computer executable code stored on computer readable medium from another memory of the system 101.

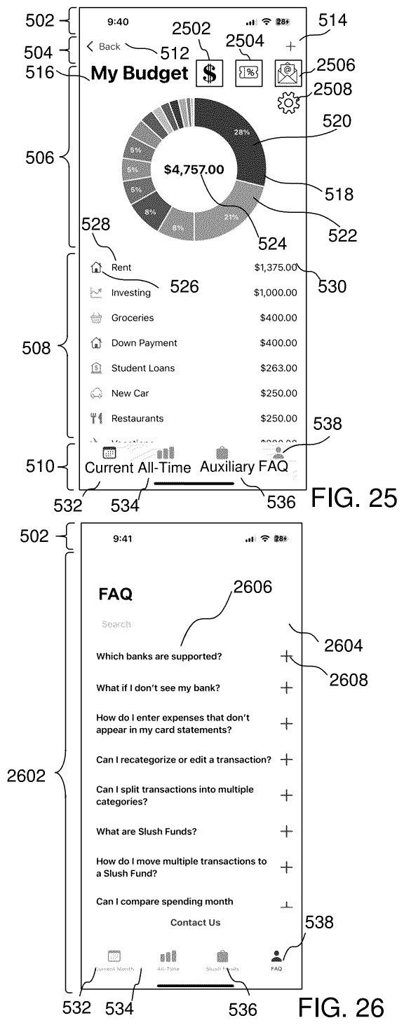

The control circuit 302 and data processing circuit 310 may implement various programs that may be beneficial to both a user of a communication device or a financial institution that operates a data processing device 102 or 104. While the various programs are shown as being implemented in the data processing device 102 or 104, it should be understood that the various programs could be implemented in a communication device 112 or communication device 116, or in a combination of a data processing device and a communication device. Programs that could be implemented could include for example is an affinity program 324, a coupon program 326, and a messaging program 328, as will be described in more detail below. The programs may include any necessary code stored on a computer readable medium necessary to operate the program and are shown by way of example, but may include other programs as will be described in more detail below in reference to FIG. 25.

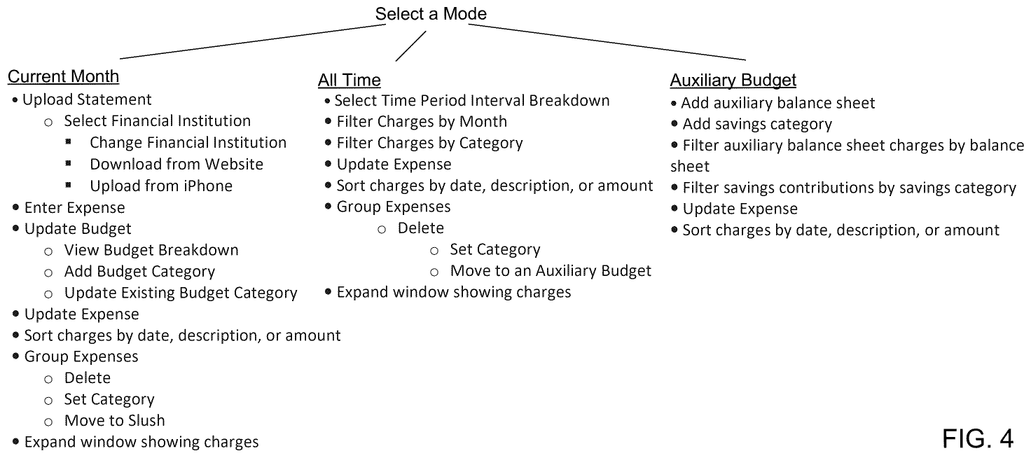

Turning now to FIG. 4, a tree diagram associated with a user interface of a communication device is shown. The tree diagram is provided for convenience for understanding some of the operations of a communication device, and will be described in more detail in reference to the various layouts for user interface elements referenced below.

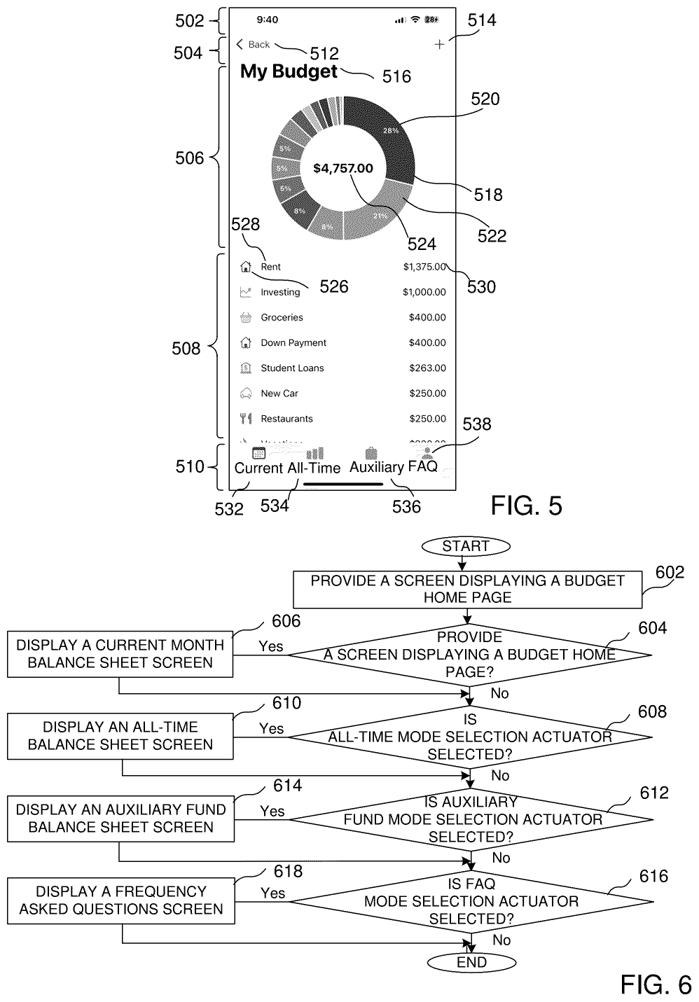

Turning now to FIG. 5, a layout of a budget user interface is shown. While the user interface of FIG. 5 and other figures below are representative of user interfaces and include various fields that enable the methods of managing financial transactions as described in reference to the user interface, it should be understood that other user interface elements could be implemented to enable the methods within the spirit and scope of the operations of the user interfaces that are described. It should be noted that the selection of a field designated as an actuation field results in enabling a function to be performed, such as adding a budget category to the budget shown in FIG. 5.

The layout of the user interface shown in FIG. 5 comprises a device status field 502 which provides information associated with the communication device such as a time, battery level, signal strength, etc., an interface actuator field 504, a graphic display field 506, a data information field 508, and a mode selection field 510. The interface action field 504 comprises a back actuator 512 to enable a user to provide an actuation by touching the touch screen display to enable application (commonly referred to as an app) to return to a previous user interface screen (where different user interface screens are shown by way of example in FIG. 4). An interface actuator field 514 designated by a + symbol is provided to enable a user to add an entry to data shown on the user interface. By way of example, an actuation of the interface action field 514 (such as placing a finger on the + symbol of a touch screen device or by moving a cursor of a computer to the location of the + symbol to enable the addition of a category of the budget of FIG. 5).

The graphic display field 506 may comprise a description field 516 which provides information about the user interface screen, shown here by way of example with a generic name such as My Budget, but could be changed by the user to provide a more specific name. The graphic display field 506 may also comprise a pie chart 518 comprising a first category 520 which is shown by way of example as comprising a first percentage of the budget and having a first color, a second category 522 which is shown by way of example as comprising a second percentage of the budget and having a second color, and a total value 524 associated with the budget.

The data information field 508 may comprise a plurality of entries, where each entry may comprise an icon 526 which may be color coded (or displayed within a color coded block) to correspond to the category of the graphic display field 506. Each entry may also comprise a category descriptor 528 associated with the budget item, such as groceries or rent, and a category value 530 representing the amount associated with the budget category and intended to be used in a given period, such as a month or a year. While the current budget is shown by way of example as a monthly budget, it should be understood that a budget could be set up representing a different time period, such as a year. As with other possible variations associated with a budget, the period for the budget can be set by selecting the settings icon and shown by way of example as a gear icon in FIG. 25.

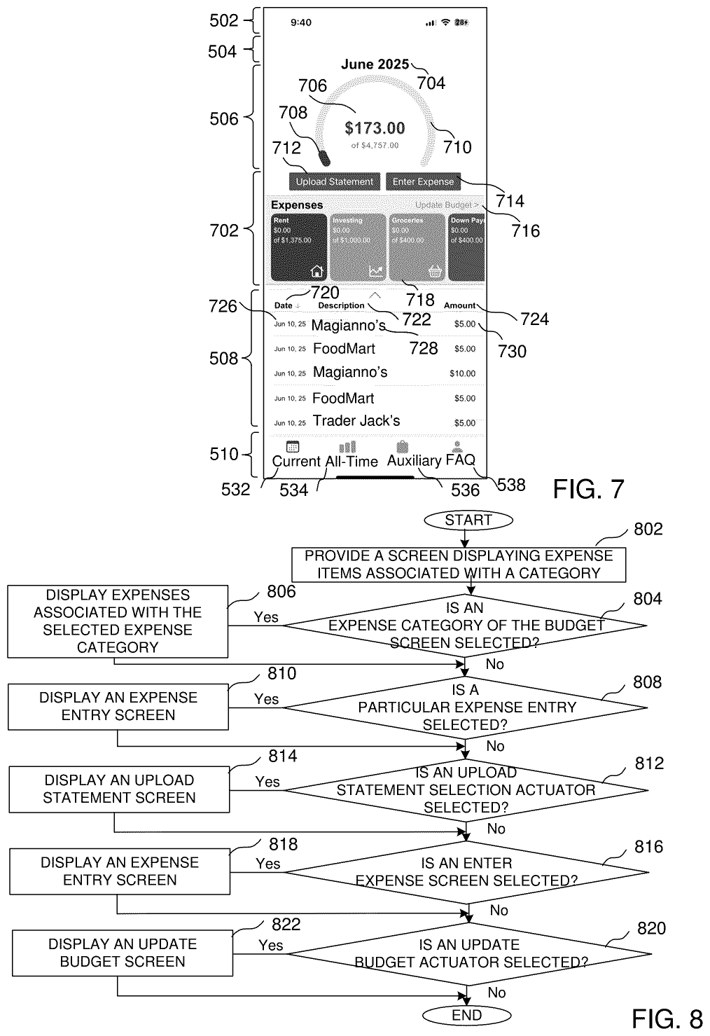

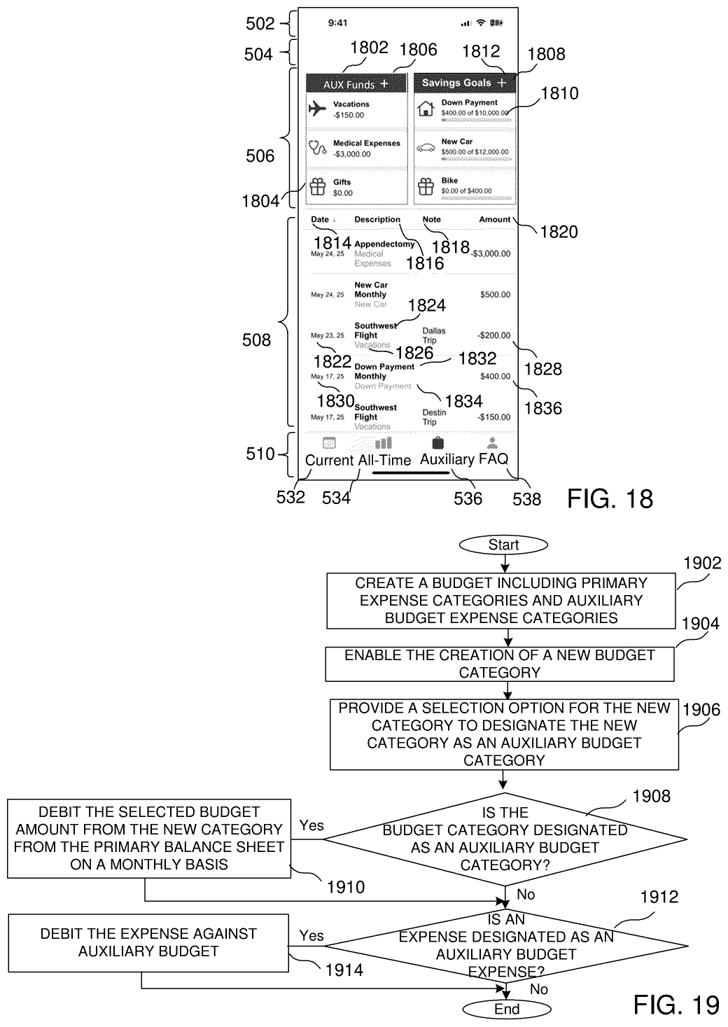

The mode selection field 510 may enable the selection of a current month mode selection actuator 532, an all-time mode selection actuator 534, an auxiliary fund mode selection actuator 536, and a FAQ mode selection actuator 538. It should be noted that an all-time mode selection actuator 534 provides similar information as when the current month mode selection actuator 532 is selected, except that data associated with a different time period is displayed, such as all-time data for expenses or another period, such as the current year to date or for the last 12 months, where the period may be selected by accessing the settings icon. The current month mode selection actuator 532 will be described in more detail in reference to FIGS. 7-10, an auxiliary fund mode selection actuator 536 will be described in more detail in reference to FIGS. 18-20, and a FAQ mode selection actuator 538 will be described in more detail in reference to FIG. 26.

Turning now to FIG. 6, a flow chart shows a method of implementing a budget user interface. The method of FIG. 6, as with other methods described in flow charts below, may be implemented using a communication device, such as a communication device of FIG. 2, alone or in combination with a data processing device, such as data processing device 102 or data processing device 104 of FIG. 1 and described above in reference to FIGS. 1-3. A screen having a budget home page is provided at a block 602. The screen may be implemented on a communication device of FIG. 1, or some other suitable communication device. It is determined whether the current month mode selection actuator, such as current month mode selection actuator 532, is selected at a block 604. A current month balance sheet screen is displayed at a block 606. A current month balance sheet screen is shown by way of example in FIG. 7, which shows expenses associated with a grocery category. It is also determined whether an all-time mode selection actuator selected at a block 608. An all-time balance sheet screen is displayed at a block 610. As described above, an all-time balance sheet screen would be similar to a current month balance sheet screen, except that the expenses may relate to a different time period. It is also determined whether an auxiliary fund mode selection actuator is selected at a block 612. An auxiliary fund balance sheet screen is displayed at a block 614. As will be described in more detail below, and more particularly in reference to FIGS. 18-20, an auxiliary fund balance sheet relates to sporadic, intermittent, or unexpected expenses. It is also determined whether an FAQ mode selection actuator selected at a block 616. A frequency asked questions screen is displayed at a block 618. An FAQ screen will be described in more detail below in relation to FIG. 26.

Turning now to FIG. 7-17, various data and actuation fields are described that relate to a primary budget and an auxiliary budget. According to some implementations, methods of uploading statements from financial platforms are described. The devices, user interfaces, systems and methods make it possible to parse through a full statement of transactions. The statements can be from savings and checking accounts associated with a bank, peer-to-peer digital transaction services (e.g., Venmo), credit cards, or any other financial institution. Statements can be in the form of a .csv, .pdf, or any other file format, including a proprietary format. The devices, user interfaces, systems and methods allow a user to quickly import all of their spending history rather than manually entering each transaction from one or more accounts that is accessed by a user. According to some implementations of the devices, user interfaces, systems and methods, a user may not be required to disclose any account information, including account login information. The devices, user interfaces, systems and methods may allow the user to simultaneously view a web browser pop-up side-by-side with directions tailored to the specific financial platform from which the user wishes to download a statement. These directions will guide the user with step-by-step instructions on how to download a statement. Once downloaded, all of the information can be processed, as will be described in more detail below. According to some implementations, transactions may be automatically categorized into budget categories based on categorizations from previous transaction, categorizations of classifications specified by the financial institution, the use of artificial intelligence relying upon available information of a user or group of users, or by any other means at the time when the statement is uploaded.

Referring specifically now to FIG. 7, a layout of a budget category user interface is shown. In addition to the other fields shown in FIG. 7, a category update and selection field 702 is shown. The graphic display field 506 may comprise a description field 704 which provides information about the user interface screen, shown here by way of example as having a date indicating the monthly period in this case indicating the month for which expenses were debited. The graphic display field 506 may also comprise a status field 706 that indicates a number that has been debited (e.g., 173.00) of a total budget number (e.g., $4,757.00). A portion 708 of a total budget number 710 (i.e., a percentage portion 173/4,757 for the portion 708 is shown for the total available budget represented by the total budget number 710). While a percentage of the budget is shown by way of the graphic display having the portion 708 and the total budget number 710, it should be understood that other visual or graphic representations could be provided.

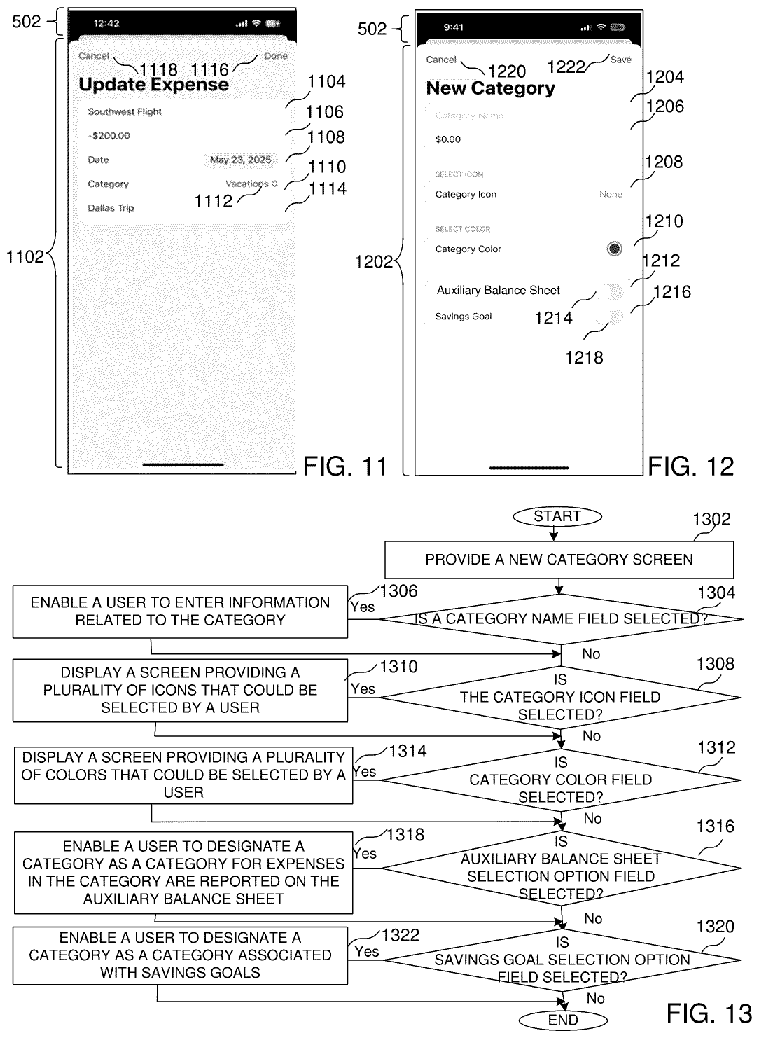

The category update and selection field 702 may comprise a selection actuator 712 for uploading a statement from a financial institution (i.e., entering an upload statement user interface screen (e.g., as shown in FIG. 15) in response to the selection of the selection actuator 712), a user interface actuator 714 for entering an expense (i.e., manually entering an expense rather than having expenses automatically added to a balance sheet when a statement is uploaded) as shown for example in reference to FIG. 11, and a selection actuator 716 for updating a budget.

While a number of different budget categories are shown, where other categories could be selected by swiping the screen showing the categories left or right, the grocery category 718 is selected here by way of example and five transactions of a plurality of transactions from example grocery stores are shown. A date column 720, a description column 722, and an expense amount column 724 are also provided to show details associated with the transactions. For example, a date of Jun. 10, 2025 is shown as the date 726, a store called Magiannos is shown as the vendor 728 and an expense of $5.00 is shown as an expense amount 730. As will be described in more detail below, a given entry can be selected, such as by touching a screen of a portable device or using a cursor on a computer. According to some implementations, a user may be able to “swipe” the touchscreen of the communication device to the right or left (or either the right or the left) to have the transaction designated as a transaction that should be recorded on the auxiliary balance sheet, as will be described in more detail below.

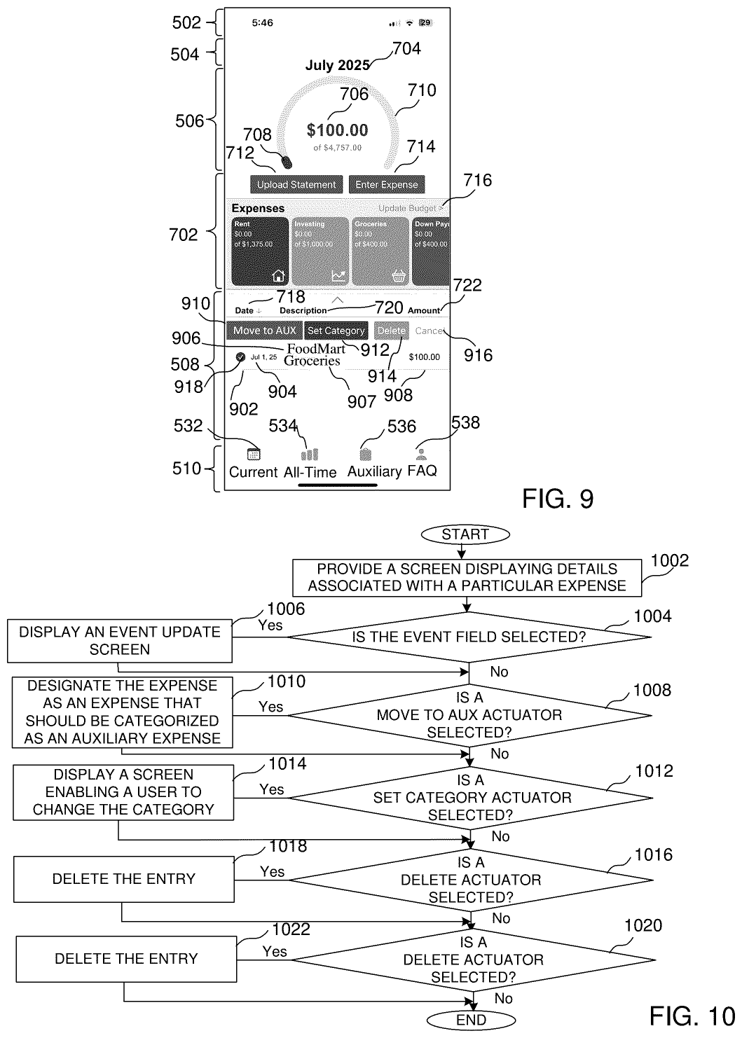

Turning now to FIG. 8, a flow chart showing a method of implementing a budget category user interface. A screen displaying expense items associated with a category is provided at a block 802. Until a specific category is selected, the expenses associated with all of the categories will be shown. It is determined whether an expense category of the budget screen is selected at a block 804. If so, expenses associated with the selected expense category are displayed at a block 806. This is shown for example in FIG. 7 for a grocery category. It is also determined whether a particular expense entry is selected at a block 808. If so, an expense entry screen is display at a block 810. This is shown by way of example for a transaction at FoodMart in FIG. 9.

Other actions may also be performed from the user interface of FIG. 7. For example, it may also be determined whether an Upload Statement selection actuator is selected at a block 812. If so, an upload statement screen is displayed at a block 814. This is shown by way of example in FIG. 15. It should be noted that a financial statement may be downloaded to a communication device, such as communication device 112 or 116, and then may be uploaded from a memory of the communication device to an app for managing financial transactions, or accessed from the memory by the app for managing financial transactions. According to other embodiments, the app may access data from a remote memory, such as a memory of a remote device, such as data processing devices 102 and 104, or some other memory. It may also also be determined whether an enter expense screen is selected at a block 816. If so, an expense entry screen is then displayed at a block 818, as shown by way of example in FIG. 17. It is also determined whether an update budget actuator is selected at a block 820. If so, a budget screen showing the information associated with the selected budget is displayed at a block 822, and can be updated with information as shown in FIG. 12. New budget category can be created, as shown in FIG. 12.

Turning now to FIG. 9, a layout of selected entries from a budget category user interface is shown. That is, when a given transaction is selected, such as the transaction at FoodMart shown in FIG. 9, additional information is shown and additional actions may be taken. More particularly, a selected entry 902 includes a date field 904 showing Jul. 1, 2025, a vendor field 906 showing FoodMart, a category field 907, which is the groceries category in this example, and an expense field 908 showing an expense of $100.

Additional actions may be taken using an interface actuator field 910, which will enable the transaction to be treated as an expense that should be recorded on the auxiliary balance sheet, as will be described in FIG. 18. That is, in addition to the option of allowing a user to “swipe” a given transaction left or right, the user interface of FIG. 9 allows one or more transactions to be designated as transactions that should be recorded on an auxiliary balance sheet. An interface actuator field 912 enables a user to set a category, as described in FIG. 11. An interface actuator field 914 enables the deletion of the selected transaction, while an interface actuator field 916 enables the cancellation of the attempt to change the transaction and returns the user to the previous budget sheet. It should be noted that a selection option 918 enables a user to select one or more transactions that may be displayed on different interfaces (shown by way of example here as a check mark provided in the circle), where a given action (such as an action be selecting interface actuator field 912) may be performed for multiple transactions.

Turning now to FIG. 10, a flow chart shows a method of editing a selected entry of a budget category. A screen displaying details associated with a particular expense is provided at a block 1002. It is determined whether the event field is selected at a block 1004. If so, an event update screen is display at a block 1006. It is also determined whether a “Move to Aux” actuator is selected at a block 1008. If so, the expense is designated as an expense that should be categorized as an auxiliary expense at a block 1010. An example of a user interface screen associated with entries on an auxiliary balance sheet is shown in FIG. 18. It is also determined whether a set category actuator is selected at a block 1012. If so, a screen enabling a user to set the category is display at a block 1014. An example of a screen enabling a user to set a category is shown in FIG. 12. It is also determined whether a delete actuator is selected at a block 1016. If so, the entry is deleted at a block 1018. It is also determined whether a cancel actuator is selected at a block 1020. If so, the entry is cancelled at a block 1022.

Turning now to FIG. 11, a layout of a user interface to update an expense entry is shown. When an actuator adapted to take a user to a user interface enabling the user to update information related to a transaction, such as by selecting an expense entry that is displayed (e.g., by pressing and holding the selected entry 902 in FIG. 9 on a communication device having a touch screen or by clicking on the selected entry 902 using cursor on a computer) is selected, information can be entered or changed for a data information field 1102, a payee field 1104, an expense amount field 1106, a date field 1108, and category field 1110. According to some implementations, a cursor selection interface 1112 may enable the selection of a category from a number of pre-entered categories, such as the categories shown by way of example in FIG. 7. A note field 1114 may also be provided to allow a user to enter a note related to a transaction. The user interface may also comprise a user interface actuator 1116 to save the data and return to a different user interface, and a user interface actuator 1118 to cancel the attempt to update the expense.

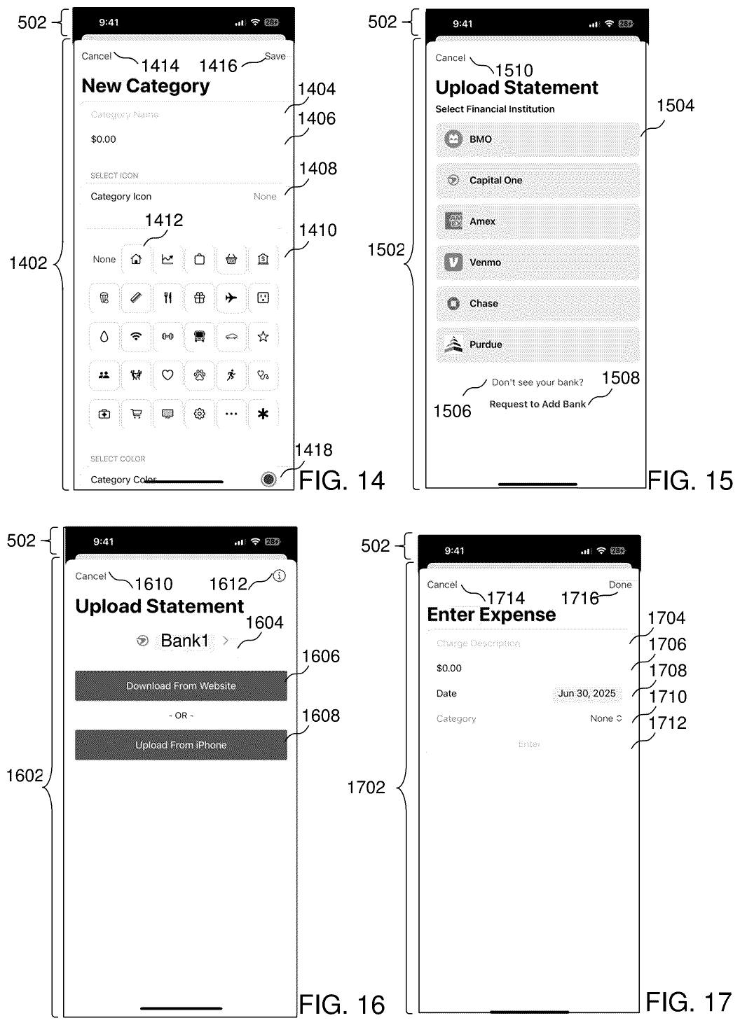

Turning now to FIG. 12, a layout of a user interface to create a new category for a budget is shown. When updating a budget, such as by selecting an actuator to update the budget (e.g., such as by selecting the selection actuator 716 to update the budget), a user can add, delete, or modify any category, or add a new category. When entering information related to a new budget category, a user can enter information in data information field 1202, a category name field 1204, a budget value 1206, a category icon selection field 1208, including information entered in a category color selection field 1210, an auxiliary balance sheet selection option field 1212 which is enabled by a slide actuator 1214, a savings goal selection option filed 1216 which is enabled by a slide actuator 1218, a cancel actuator 1220, and a save actuator 1222. An example of selecting a category icon field will be described in more detail in reference to FIG. 14.

Turning now to FIG. 13, a flow chart shows a method of creating a new category for a budget. If so, a new category screen is provided at a block 1302. It is determined whether a category name field is selected at a block 1304. If so, a user is enabled to enter information related to the category at a block 1306. It is also determined whether the category icon field is selected at a block 1308. If so, a screen providing a plurality of icons that could be selected by a user is display at a block 1310. It is also determined whether a category color field is selected at a block 1312. If so, a screen providing a plurality of colors that could be selected by a user is display at a block 1314. It is also determined whether an auxiliary balance sheet selection option field is selected at a block 1316. If so, a user is enabled to designate a category as a category for expenses in the category are reported on the auxiliary balance sheet at a block 1318. It is also determined whether a savings goal selection option field is selected at a block 1320. If so, a user is enabled to designate a category as a category associated with savings goals at a block 1322. The method of FIG. 14 may be performed using the user interface of FIG. 13, or some other suitable user interface.

Turning now to FIG. 14, a layout of a user interface for selecting information associated with a new budget category is shown. When creating a new budget category, information can be entered in a data information field 1402, a category name field 1404, a category budget amount 1406, a category icon 1408, a user selectable field 1410, a icon 1412, a cancel actuator 1414, a save actuator 1416, and a category color field 1418.

Turning now to FIG. 15, a layout of a user interface for uploading a financial statement to a budget is shown. When uploading a financial statement comprising one or more transaction entries (e.g., a debit transaction associated with debiting an account or a credit transactions associated with crediting an account), a data information field 1502 is provided and may comprise available financial institutions field 1504 listing financial institutions from which a user can upload data. Various actuators for providing assistance may also be provided. For example, a user assistance field 1506 may be provided to learn a course of action that may be available if a particular financial institution such as a bank is not listed, while a user assistance field 1508 may be provided to request to add a financial institution, such as a bank. An actuator field 1510 may also be provided to enable the cancellation of the upload operation.

Turning now to FIG. 16, another layout of a user interface for uploading a financial statement to a budget is shown. By way of example, the user interface of FIG. 16 may be provided in response to the selection of the financial institution Bank 1. A data information field 1602 comprises a user interface actuator 1604 enabling a user to select a different financial institution, a user interface actuator 1606 enabling a user to download financial information from a selected financial institution and a user information actuator 1608 enabling a user to upload financial information from a communication device, such as a mobile phone. While two options are shown by way of example in FIG. 16 for providing financial data to an app for managing financial transactions, it should be understood that other options may be available to provide data to an app for managing financial transactions. The user interface may also provide a user interface actuator 1610 to cancel the attempt to receive financial information from a financial institution or stored in a communication device, and a user interface actuator 1612 to receive additional information. Financial information may include banking data, credit card data, savings data, investment data, and any other information related to financial transactions, for example.

Turning now to FIG. 17, a layout of a user interface for entering an expense to a budget is shown. While it is convenient to download financial data to be accessed by an app for managing financial transactions, it is also possible to manually enter data, such as in response to the selection of a user interface actuator 714, as shown for example in FIG. 7. When manually entering information associated with a financial transaction, a user may enter data in a data information field 1702, a expense description field 1704, an expense amount 1706, a date field 1708, and a category selection field 1710 according to the implementation of FIG. 17. A user may also be able to select an actuator 1712 to enter or store the data, a user interface actuator 1714 to cancel the manual entry of an expense, or a user interface actuator 1716 to save the entered data.

Additional fields related to an auxiliary budget are described in relation to FIGS. 18-20. According to other implementations, the devices, user interfaces, systems and methods relate to the creation and modification of auxiliary balance sheets. Contributions to the auxiliary funds may be logged as an expense in a primary balance sheet, which may represent a main monthly balance sheet. The user can make withdrawals from the auxiliary balance sheet for sporadic, intermittent, or unexpected expenses, which may be considered generally as irregular expenses. These irregular expenses may be difficult to predict or estimate on a monthly base, but possibly easier to predict or estimate on an annual basis. The use of an auxiliary balance sheet allows the user to keep these irregular expenses off of the primary balance sheet, so as to enable a user to closely track their monthly spending in a way that will allow them to more easily identify when they are exceeding their budget in areas that are easy to track, and also to allocate room in the budget for irregular expenses that will likely be allocated at different times of the year. The devices, user interfaces, systems and methods also allow the user to smooth the expenses over the course of a year by breaking it down into more manageable monthly expenses (i.e., auxiliary balance sheet contributions), knowing that those expenses will not necessarily be incurred, but that on average over the year, expenses in those categories will be incurred over the year and will be equal to (or hopefully less than) the budgeted amount for the year. According to some implementations, the use case for such auxiliary balance sheet expenses would be for expenses that the user knows will inevitably come up throughout the year but without a clear idea of when during the year. Examples of such expenses could be out of pocket medical expenses, vacation/travel expenses, gifts, and any other expenses that the user does not necessarily incur every month, but often comes unexpectedly or non-monthly but rather periodically throughout the year. When the user enters an expense or uploads them from a financial statement, the user may specifically designate which charges should be classified as a withdrawal from one of the categories of an auxiliary balance sheet. This promptly removes the expense from the main monthly budget and transfers it to the auxiliary balance sheet, making it easier for a user to evaluate whether they are staying within budget in a given month for their ordinary expenses that may be incurred on a monthly basis.

The auxiliary balance sheet may provide additional functionality that is beneficial to a user. There are several physical embodiments of what these monthly contributions to the auxiliary balance sheet represent. At its most basic level, a user may designate monthly contributions that can be moved from their checking account to savings account, for example. The auxiliary balance sheet could be physically embodied by separate savings accounts for each sheet. The auxiliary balance sheet could be physically embodied by separate high yield savings accounts for each sheet. The auxiliary balance sheet could be physically embodied by separate investment accounts for each sheet. The auxiliary balance sheet could be physically embodied by a combination of one or more separate investment accounts and savings accounts. The auxiliary balance sheet could be tied to a corporate rewards system. For example, an auxiliary balance sheet could be tied to an airlines reward system for vacation/travel expenses allocated to a vacation fund associated with a given airlines, where points may be awarded or a discount given when a user allocates a certain amount to a category of the auxiliary balance sheet for the airlines then makes an airfare purchase for travel with the airline. That is, the user would contribute a balance sheet sponsored by the airline, and withdraw from it when booking travel. The airline could offer the user points, a price discount, a seating upgrade, free beverages, a reduced fare for a companion, a reduced fair on a future flight, or some other benefit if the withdrawals from their balance are booked with that airline. According to some implementations, any amount allocated to the category for the airline would be paid out to the airline, where the airline sponsoring the category for the user could be investing the contributions and offer the user a percentage of their return on the investment as well. While a category for an airline is given by way of example, it should be understood that this type of investment arrangement could apply to any other type of company, product or service, including for example, hotels, real estate sales, real estate rentals (e.g., Air BnB, VRBO, etc.), car rentals, cars, motorcycles, homes, bikes, boats, audio equipment, movie tickets, concert tickets, etc.

Referring now specifically to FIG. 18, a layout of a user interface for accessing fund categories and entries and saving goals categories and entries is shown. An auxiliary fund list 1802, which may include one or more auxiliary fund categories 1804, including for example a vacations auxiliary fund, a medical auxiliary fund and a gifts auxiliary find. As mentioned above, vacation, medical and gift expenses may, for some people, fall under the category of expensed that are sporadic, intermittent, or unexpected expenses. The user interface of FIG. 18 may also include a user selectable option 1806 to add a new auxiliary fund category.

Savings goals may also be displayed with categories and transactions associated with auxiliary expense categories. More particularly, a savings goal list 1808, includes savings categories 1810, shown by way of example as a home downpayment category, a new car category and a bike category. The user interface also includes a user selectable option 1812 for adding a new category. The user interface also includes transactions that are recorded (i.e., debited) for the auxiliary funds category and designations of amounts allocated for savings categories. According to some implementations, the designations of savings to a given savings category may be an actual savings transaction, such as the transfer of funds from a checking account associated with the primary budget to a separate account, such as a separate savings account. According to other implementations, amounts designated as savings amounts in budget categories associated with savings goals may be indicated as deducted from the account even though there is no actual financial transaction. That is, while no money is transferred to a savings account, a user will still see a deduction on the budget report as if a transfer had taken place. This apparent transaction may help the user save by making it appear that the funds allocated to a savings category are not available to spend.

The categories for the auxiliary balance sheet may be similar to the primary balance sheet, and may comprise a date column 1814, a description column 1816, a note column 1818, and an amount column 1820. According to a first example of a transaction, May 23, 2025 shown in the date field 1822, Southwest shown in the payee field 1824, vacations in the auxiliary payment category 1826, and $400 expense amount 1828. According to a second example, May 17, 2025 is recorded in a date field 1830, down payment in the savings goal description 1832, down payment in the savings goal category 1834, and $150 in the savings amount 1836.

According to other implementations, for any auxiliary budget category, after expenses that are auxiliary expenses associated with an auxiliary budget category are debited to the account, any remaining amount (i.e., the total of the debited auxiliary expenses for the auxiliary budget category for the month subtracted from the amount designated in an auxiliary budget category) may be transferred from the account associated with the primary budget to a separate account. That is, rather than providing the appearance that the amounts designated as an expense in an auxiliary budget category are “deducted” from the available funds (i.e., it appears that the funds are not available to the owner of the account), some or all of the amounts designated as an expense in an auxiliary category are actually deducted from the account associated with the primary budget of the user. For example, a user may indicate that $150 per month be designated to a vacations auxiliary account. Rather than just deducting it from the amount that the user believes is available, the $150 is actually transferred to another account, such as a savings account (associated with the account for the primary budget), or a separate savings or investment account. If a $75 expense is actually debited to the vacation auxiliary expense, then $75 might be transferred to a separate account. According to some implementations, the designated amounts can be transferred to a company that may hold the funds for future purchases. For example, funds designated for a vacation auxiliary budget expense may be paid to an airline that will provide discounts or reduced airfare for future purchases. While expenses associated with auxiliary funds are actually debited from an account, any remaining amount may be transferred to some other type of savings or investment account, but those transferred funds may later be accessed when expenses are incurred for auxiliary fund categories. That is, the owner of the account may benefit from a higher interest rate for funds designated for auxiliary categories but not expensed in a given month.

According to some implementations, the amount transferred may be determined by the app based upon settings selected by the user. For example, the app may automatically transfer the amount designated in auxiliary budget categories to a saving account, investment account or company. According to other implementations, the amount transferred may be based upon the amount of the budget already expended. For example, if the monthly budget is $4,500 and only $4,000 is actually spent, the remaining $500 will be transferred out of the account. If $500 is less than the amount designated as expenses in an auxiliary budget, the $500 can be transferred to a default account, or can be divided proportionally and transferred to various accounts proportionately based upon the amounts designated for the different categories. For example, if only $250 of the budgeted $500 remains, half of the amount would be transferred for each budget category. Alternatively, the $250 could be allocated to accounts based upon a priority order of the accounts, where the full amounts are transferred to the accounts in the priority order until the $250 is transferred.

A similar arrangement may exist for savings, where amounts designated as savings may be transferred to savings account, investment account, or an account associated with a company. That is, although savings amounts for a savings category of the auxiliary budget may not be actually debited, they can be debited from the available budget amount and the funds actually transferred to a different account. In the event that the available amount left in the budget for the month is less than the amount designated for savings, the amount transferred could be determined proportionally or based upon priority for the savings amounts. According to some implementations, a user could establish preferences for transfers to auxiliary budget accounts and saving budget accounts is not enough is available at the end of the month to cover both the amounts designated for auxiliary budget accounts and saving budget accounts.

Turning now to FIG. 19, a flow chart shows a method of implementing a budget having auxiliary funds. FIG. 19 shows the “deduction” of a budget amount for an auxiliary budget category, such as a monthly budget amount, from a budget, and an actual debiting of a given expense in a balance sheet of an auxiliary balance account. That is, an entire amount of a budget category is deducted from a budget periodically, such as monthly, while actual expenses are debited from an auxiliary budget when it occurs.

More particularly, a budget including primary expense categories and auxiliary budget expense categories is created at a block 1902. The creation of a new budget category is enabled at a block 1904. A selection option for the new category to designate the new category as an auxiliary budget category is provided at a block 1906. By way of example, the plus symbol 1806 could be selected. It is then determined whether the budget category is designated as an auxiliary budget category at a block 1908. This could be accomplished by the user designating a given transaction as an auxiliary budget transaction. The selected budget amount associated with a given category may be debited from the new category from the primary balance sheet on a monthly basis at a block 1910. It is also determined whether a given expense is designated as an auxiliary budget expense at a block 1912. By way of example, an expense could be designated as an auxiliary budget expense by swiping an expense as described above, or moving an item to an auxiliary budget as described in reference to FIG. 9. The expense recorded in the auxiliary budget at a block 1914. The method of FIG. 19 could be implemented as described using the user interface of FIG. 18 for example, or some other suitable user interface.

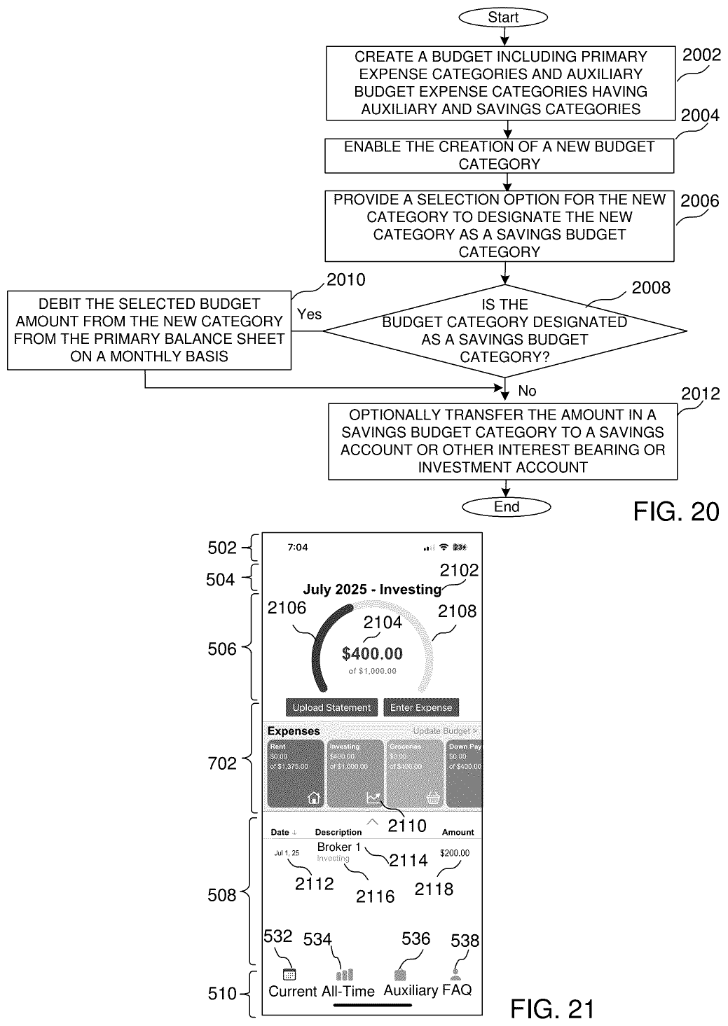

The auxiliary balance sheet also accommodates savings that are deducted from a budget (even if an actual transfer of funds does not occur), but shown as an asset in a saving budget category. According to some implementations, amounts designated as saving will be debited on the auxiliary balance sheet if an actual transfer of funds to an account, such as a savings account occurs. Referring specifically to FIG. 20, a flow chart shows a method of implementing a budget having savings goals. A budget including primary expense categories and auxiliary budget expense categories having auxiliary and savings categories is created at a block 2002. The creation of a new budget category is enabled at a block 2004. A selection option for the new category to designate the new category as a savings budget category provided at a block 2006. It is determined whether the budget category is designated as a savings budget category at a block 2008. The selected budget amount is debited from the new category from the primary balance sheet on a monthly basis at a block 2010. The amount in a savings budget category may be optionally transferred to a savings account or other interest bearing or investment account at a block 2012.

Investment options are now described in reference to FIGS. 21-24. According to the implementation of FIG. 21, an investment expense may be treated like other expenses, where a payment is made, in some cases automatically, to a financial institution or other investment firm. That is, the expense will appear on the primary balance sheet as any other debited expense. Referring first to FIG. 21, a layout of a user interface of an investment category of a budget is shown, and includes a description field 2102, a current expenses as a portion of a budget 2104, a portion 2106, and total budget value 2108. An investment expense category actuator 2110 is selected here by way of example to show investment expenses. For example, when the user places their finger on a touchscreen or uses a cursor to select the investment category, the investment category will be highlighted and transactions associated with the investment category will be shown in the data information field 508. According to the example, a date field 2112 includes a date of Jul. 1, 2025, a payee field 2114 indicates a payment to Broker 1, a payment category 2116 includes a category of Investment Payment, and an expense amount 2118 includes an amount of $200.

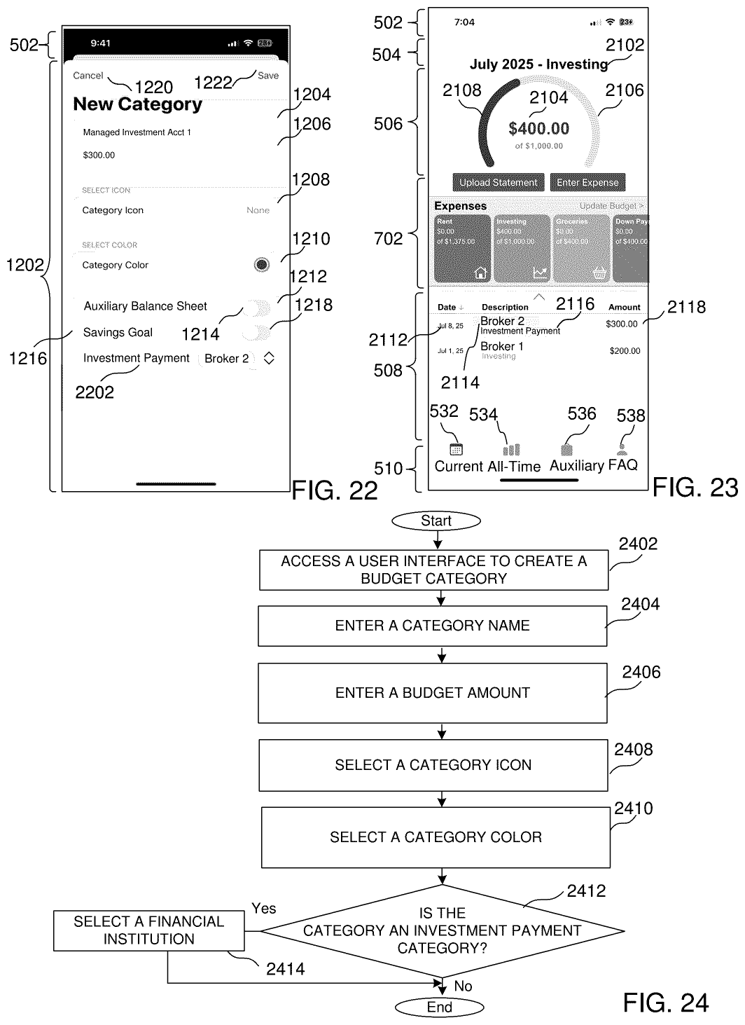

Turning now to FIG. 22, a layout of a user interface enabling the entry of a new category is shown. The layout of FIG. 22 allows for the creation of a new category for an different type of investment than described above in reference to FIG. 21. More particularly, unlike a pull transaction where a bank automatically charges a primary account for an investment expense, the app could also function to provide a push transaction. That is, the app could transfer funds to an investment firm rather than allowing the investment firms to charge an investment expense against the bank account of the user. The user could add a new investment category which could be designated as an investment payment that enables the user to make a payment to the financial institution rather than allowing the financial institution to make a deduction from the bank account of the user. As shown in FIG. 22, the user interface may include a field 2202 that enables a user to create an investment payment that would be made to a selected financial institution, shown here by way of example as Broker 2, where different financial institutions could be selected using the up and down arrow shown to the right of the selected financial institution. When a user accesses the investing category, the user may see different types of investment transactions as will be described in reference to FIG. 23.

Turning now to FIG. 23, another layout of a user interface of an investment category of a budget showing an entry associated with a managed investment account (i.e., an investment transaction payment associated with push transaction) is shown. The two different types of investment transactions are shown by way of example in FIG. 23. That is, in addition to the expense to Broker 1 debited on Jul. 1, 2025 as shown in FIG. 21, an investment payment transaction is shown as being made on Jul. 8, 2025 designated in the date field 2112, to Broker 2 designated in the payee field 2114, as a investment payment in the payment category 2116, and for an amount of $300 in the expense amount 2118.

Turning now to FIG. 24, flow chart shows a method of implementing a user interface of an investment category of a budget. A user interface to create a budget category access at a block 2402. A category name enter at a block 2404. A budget amount enter at a block 2406. A category icon select at a block 2408. A category color select at a block 2410. It is then determined whether the category is an investment payment category at a block 2412. That is, unlike a situation where a user may access a website or app of an investment firm to having the investment firm charge the user's account for an investment expense, the user can establish a push transaction (i.e., a payment originated by the app for a payment from the user's account to an investment firm or other financial institution. A financial institution (e.g., investment firm to which the investment payment is made by the app) is selected at a block 2414.

Turning now to FIG. 25, a layout of a user interface showing additional icons to access additional information and control an operation of the user interface is shown. As shown in FIG. 25, various user interfaces may be accessed to provide beneficial functions, such as affinity programs accessible by an affinity programs icon 2502, coupons accessible by a coupon icon 2504, messages accessible by a messaging icon 2506. and settings accessible by a settings icon 2508. An affinity program may provide a user of the app “points” for purchases made using an account associated with the app. For example, The app may recognize a purchase from a particular vendor, such as a food store. When the app recognizes a transaction with the particular vendor, the app may allocate points for the purchase. That is, the vendor may have an arrangement with a developer of the app or a financial institution that may be providing the app for their customers to provide some financial benefit to a user of the app based upon purchases from the vendor. The benefit may come as a coupon provided to the user of the app, such as through a messaging feature of the app, which may be accessible by way of the coupon icon. If the user of the app also happens to have a corresponding vendor app associated with the vendor, the app will provide information related to the purchase to the vendor app. The vendor app may then determine whether the user has already received credit for the purchase (e.g., such as by comparing time, date and purchase amount data related to the purchase to time, date and purchase amount data already recorded by the app which may have been received based upon the user using the vendor app during the purchase). If the user did not receive credit for the purchase, the vendor app will provide the necessary credit for the purchase to the app, where a message may be provided to the user and accessible by the messaging icon.

Turning now to FIG. 26, a layout of a user interface enabling frequency asked questions, and may comprise list 2602. search field 2604. frequently asked question 2606. expansion actuator 2608.

According to one aspect, a communication device for processing financial transaction data may comprise a communication interface for receiving financial data; a processor coupled to the communication interface and adapted to receive the financial data; and a display coupled to the processor and adapted to display financial data; wherein the processor is adapted to transfer funds designated as a savings goal to a savings account.

According to one aspect, a method of processing financial transaction data may comprise receiving financial data; coupling a processor to the communication interface and adapted to receive the financial data; and coupling a display to the processor and adapted to display financial data; wherein the processor is adapted to transfer funds designated as a savings goal to a savings account.

According to one aspect, a computer-readable storage medium having data stored therein representing software executable by a computer for processing financial transaction data, the computer-readable storage medium comprising; instructions for coupling a processor to the communication interface and adapted to receive the financial data; and instructions for coupling a display to the processor and adapted to display financial data; wherein the processor is adapted to transfer funds designated as a savings goal to a savings account.

According to other aspects, the financial data comprises one or more of banking data, credit card data, savings data, and investment data.

According to other aspects, the primary balance sheet comprises financial transactions that are incurred by a user.

According to other aspects, the primary balance sheet comprises one or more categories for allocating financial transactions to the auxiliary balance sheet.

According to other aspects, the primary balance sheet comprises a category for designating a desired savings amount.

According to other aspects, the auxiliary balance sheet displays financial transactions for recorded expenses for a selected period of time.

According to other aspects, the auxiliary balance sheet displays a cumulative amount of savings for a selected time period.

According to other aspects, the auxiliary balance sheet displays a cumulative amount of savings for a selected time period.

According to other aspects, a plurality of savings goals can be contributed to one or more savings accounts.

According to other aspects, where a savings account may be related to an account associated with the primary balance sheet.

According to other aspects, where a savings account may be separate from an account associated with the primary balance sheet.

According to another aspect, a communication device for processing financial transaction data may comprise a communication interface for receiving financial data; a processor coupled to the communication interface and adapted to receive the financial data; and a display coupled to the processor and adapted to display financial data; wherein the processor is adapted to transfer funds designated as an investment goal to an investment account.

According to another aspect, a method of processing financial transaction data may comprise receiving financial data; coupling a processor to the communication interface and adapted to receive the financial data; and coupling a display to the processor and adapted to display financial data; wherein the processor is adapted to transfer funds designated as an investment goal to an investment account.

According to another aspect, a computer-readable storage medium having data stored therein representing software executable by a computer for processing financial transaction data, the computer-readable storage medium comprising; instructions for coupling a processor to the communication interface and adapted to receive the financial data; and instructions for coupling a display to the processor and adapted to display financial data; wherein the processor is adapted to transfer funds designated as an investment goal to an investment account.

According to other aspects, the financial data comprises one or more of banking data, credit card data, savings data, and investment data.

According to other aspects, the primary balance sheet comprises financial transactions that are incurred by a user.

According to other aspects, the primary balance sheet comprises one or more categories for allocating financial transactions to the auxiliary balance sheet.

According to other aspects, the primary balance sheet comprises a category for designating a desired savings amount.

According to other aspects, the auxiliary balance sheet displays financial transactions for recorded expenses for a selected period of time.

According to other aspects, the auxiliary balance sheet displays a cumulative amount of savings for a selected time period.

According to other aspects, the auxiliary balance sheet displays a cumulative amount of savings for a selected time period.

According to other aspects, a plurality of savings goals can be contributed to one or more savings accounts.

According to other aspects, where an investment account may be related to an account associated with the primary balance sheet.

According to other aspects, where an investment account may be separate from an account associated with the primary balance sheet.

According to another aspect, a communication device for processing financial transaction data may comprise a communication interface for receiving financial data; a processor coupled to the communication interface and adapted to receive the financial data; and a display coupled to the processor and adapted to display financial data; wherein the processor is adapted to transfer funds designated as an auxiliary expense to a separate account, such as a savings account or an investment account.

According to another aspect, a method of processing financial transaction data may comprise receiving financial data; coupling a processor to the communication interface and adapted to receive the financial data; and coupling a display to the processor and adapted to display financial data; wherein the processor is adapted to transfer funds designated as an auxiliary expense to a separate account, such as a savings account or an investment account.

According to another aspect, a computer-readable storage medium having data stored therein representing software executable by a computer for processing financial transaction data, the computer-readable storage medium comprising; instructions for coupling a processor to the communication interface and adapted to receive the financial data; and instructions for coupling a display to the processor and adapted to display financial data; wherein the processor is adapted to transfer funds designated as an auxiliary expense to a separate account, such as a savings account or an investment account.

According to other aspects, the separate account could be a savings account associated with an account for the primary balance sheet or a separate savings account, such as a savings account associated with a separate financial institution.

According to other aspects, the financial data comprises one or more of banking data, credit card data, savings data, and investment data.

According to other aspects, the primary balance sheet comprises financial transactions that are incurred by a user.

According to other aspects, the primary balance sheet comprises one or more categories for allocating financial transactions to the auxiliary balance sheet.

According to other aspects, the primary balance sheet comprises a category for designating a desired savings amount.

According to other aspects, the auxiliary balance sheet displays financial transactions for recorded expenses for a selected period of time.

According to other aspects, the auxiliary balance sheet displays a cumulative amount of savings for a selected time period.

According to other aspects, the auxiliary balance sheet displays a cumulative amount of savings for a selected time period.

According to other aspects, a plurality of savings goals can be contributed to one or more savings accounts.

According to other aspects, where an investment account may be related to an account associated with the primary balance sheet.

According to other aspects, where an investment account may be separate from an account associated with the primary balance sheet.

Applicant claims the following:

1. A communication device for processing financial transaction data, the communication device comprising:
a communication interface for receiving financial data;
a processor coupled to the communication interface and adapted to receive the financial data; and
a display coupled to the processor and adapted to display financial data;
wherein the processor is adapted to allocate financial data to one or both of a primary balance sheet and an auxiliary balance sheet.

2. The communication device of claim 1, wherein the financial data comprises one or more of banking data, credit card data, savings data, and investment data.

3. The communication device of claim 1, wherein the primary balance sheet comprises financial transactions that are incurred by a user.

4. The communication device of claim 1, wherein the primary balance sheet comprises one or more categories for allocating financial transactions to the auxiliary balance sheet.

5. The communication device of claim 1, wherein the primary balance sheet comprises a category for designating a desired savings amount.

6. The communication device of claim 1, wherein the auxiliary balance sheet displays financial transactions for recorded expenses for a selected period of time.

7. The communication device of claim 1, wherein the auxiliary balance sheet displays a cumulative amount of savings for a selected time period.

8. A computer-readable storage medium having data stored therein representing software executable by a computer for processing financial transaction data, the computer-readable storage medium comprising:
instructions for receiving financial data;
instructions for a processor coupled to a communication interface and adapted to receive the financial data; and
instructions for a display coupled to the processor and adapted to display financial data;
wherein the processor is adapted to allocate financial data to one or both of a primary balance sheet and an auxiliary balance sheet.

9. The computer-readable storage medium of claim 8, wherein the financial data comprises one or more of banking data, credit card data, savings data, and investment data.

10. The computer-readable storage medium of claim 8, wherein the primary balance sheet comprises financial transactions that are incurred by a user.

11. The computer-readable storage medium of claim 8, wherein the primary balance sheet comprises one or more categories for allocating financial transactions to the auxiliary balance sheet.

12. The computer-readable storage medium of claim 8, wherein the primary balance sheet comprises a category for designating a desired savings amount.

13. The computer-readable storage medium of claim 8 wherein the auxiliary balance sheet displays financial transactions for recorded expenses for a selected period of time.

14. A method of processing financial transaction data, the method comprising:
receiving financial data by way of a communication interface;
coupling a processor to the communication interface, wherein the processor is adapted to receive the financial data; and
coupling a display to the processor, wherein the display adapted to display financial data;
allocating, by the processor, financial data to one or both of a primary balance sheet and an auxiliary balance sheet.

15. The method of claim 14, wherein receiving financial data comprises receiving one or more of banking data, credit card data, savings data, and investment data.

16. The method of claim 14, wherein the primary balance sheet comprises financial transactions that are incurred by a user.

17. The method of claim 14, wherein the primary balance sheet comprises one or more categories for allocating financial transactions to the auxiliary balance sheet.

18. The method of claim 14, wherein the primary balance sheet comprises a category for designating a desired savings amount.

19. The method of claim 14, wherein the auxiliary balance sheet displays financial transactions for recorded expenses for a selected period of time.

20. The method of claim 14, wherein the auxiliary balance sheet displays a cumulative amount of savings for a selected time period.
